(19) United States
(12) Patent Application Publication
(10) Pub. No.: US 2012/0017072 A1
(43) Pub. Date: Jan. 19, 2012

(54) MODIFYING A VIDEO RESOLUTION OF VIDEO DATA IN A PRE-OPERATING SYSTEM ENVIRONMENT

(76) Inventor: Kurt David Gillespie, Houston, TX (US)

(21) Appl. No.: 13/259,559

(22) PCT Filed: Jul. 14, 2009
(86) PCT No.: PCT/US09/50483

§ 371 Date: Sep. 23, 2011

(51) Int. Cl. G06F 9/00; H04N 7/01

(52) U.S. Cl. 713/2; 348/441; 348/E07.003

(57) ABSTRACT

Code (104) is run in a computer (100) to establish a pre-operating system (OS) environment. Video data is generated in the pre-OS environment for display at a display device (122), where the video data has a first video resolution. A video resolution of the video data is modified to provide a second video resolution, where the video data having the second video resolution is output for display at a display device.

### BACKGROUND

When a computer is initially started, code is executed to perform boot services, which include initializing and testing computer components, and other tasks. At the end of the boot procedure, an operating system (OS) is loaded.

In the pre-OS environment (prior to loading of the OS), certain applications may run, and such applications may output video data for display at a display device of the computer. For example, some applications may output status information during the boot procedure to indicate whether any faults are detected.

Some applications that operate in a pre-OS environment are designed to output video data having a particular video resolution. In some cases, there may be incompatibilities between the resolution specified by the application video data and the resolution supported by a display device of a computer.

### BRIEF DESCRIPTION OF THE DRAWINGS

Some embodiments of the invention are described with respect to the following figures:

FIG. 1 is a block diagram of an exemplary computer that incorporates a video downscaler according to an embodiment;

FIG. 2 is a block diagram illustrating various layers including the video downscaler according to an embodiment;

FIG. 3 is a flow diagram of system operation according to an embodiment; and

FIG. 4 is a flow diagram of a process performed by the video downscaler according to an embodiment.

### DETAILED DESCRIPTION

Upon startup of a computer, a boot procedure is performed in which various tests, initializations, and other tasks are performed. Traditionally, such a boot procedure is performed by the basic input/output system (BIOS) code. The BIOS code traditionally identifies, tests, and initializes system components. The BIOS code can also perform other tasks. At the end of the boot procedure, the BIOS code loads an operating system (OS).

More recently, an Extensible Firmware Interface (EFI) has been defined to provide code that performs tasks traditionally performed by BIOS code in addition to other tasks. The EFI code provides boot services as well as other services that are not available or standardized with traditional BIOS code. The EFI code also includes a boot manager for loading an operating system. The EFI specification is provided by the Unified EFI (UEFI) Forum.

The EFI is an interface between the operating system (and/or application software) and platform firmware, where platform firmware refers to programmable content embedded in hardware components, such as microprocessors, application-specific integrated circuits (ASICs), programmable logic devices, peripheral devices, and so forth. The platform firmware can include code to perform management of health of the computer. The platform firmware can also include certain BIOS code, such as BIOS code to perform power management tasks or to provide video capabilities.

Prior to loading of the operating system, during execution of the BIOS code or EFI code, various applications may run in the pre-OS environment, such as by using EFI-provided APIs (application programming interfaces) and functionality. The pre-OS environment refers to an environment after the BIOS/EFI code has started running but prior to loading of the OS. Examples of applications that can run in the pre-OS environment include a preboot application (such as an application that allows access, in the pre-OS environment, to email or calendar data associated with an application such as Microsoft Outlook), a test application (that performs certain tests in the pre-OS environment), a graphical package for system setup, and other applications. Most of the applications that run in the pre-OS environment produce video data that is to be output on a display device.

When applications that are able to output video data in a pre-OS environment are developed, developers may assume that the applications are to operate in computers having display devices that support at least a certain video resolution (e.g., 1024×768). However, such an assumption may be incorrect, and the applications may in fact run in computers with display devices that do not support the particular resolution assumed for the applications. For example, certain computers may employ smaller display devices, such as “netbooks” (which are cheaper computers designed for wireless communication and access to the Internet). For example, some “netbooks” support only a video resolution of 800×600. Other computers may support a video resolution of 1024×720, which is less than 1024×768.

Although example video resolutions have been given above, it is noted that other implementations can employ other video resolutions.

Typically, it would be expensive to redesign applications that operate in the pre-OS environment to output video data at a lower video resolution. Redesigning applications can be time consuming, since developers have to change the code of the applications, followed by application testing.

In accordance with some embodiments, to address the issue of an application outputting video data, in a pre-OS environment, at a video resolution that is greater, in height or width, than the video resolution supported by a display device of a computer, a video resolution modifier module is provided that executes in the pre-OS environment for modifying a resolution of video data from the application to be consistent with the resolution supported by the display device of the computer. One type of the video resolution modifier module is a downscaler, which reduces the video resolution of the video data from the application. In the ensuing discussion, reference is made to use of a downscaler; however, it is noted that in alternative embodiments, the same techniques can be applied to a video resolution modifier module that can increase the video resolution of video data from the application.

Generally, in accordance with some embodiments, an application that executes in the pre-OS environment outputs video data at a first resolution. This video data at the first resolution is received by the downscaler, which applies video resolution modification to reduce the resolution to a second resolution that is consistent with a resolution supported by the display device of the computer. The downscaler then outputs the modified video data having the second resolution to video firmware, which is the interface to a video adapter of the computer, to cause the modified video data to be output on the display device of the computer.

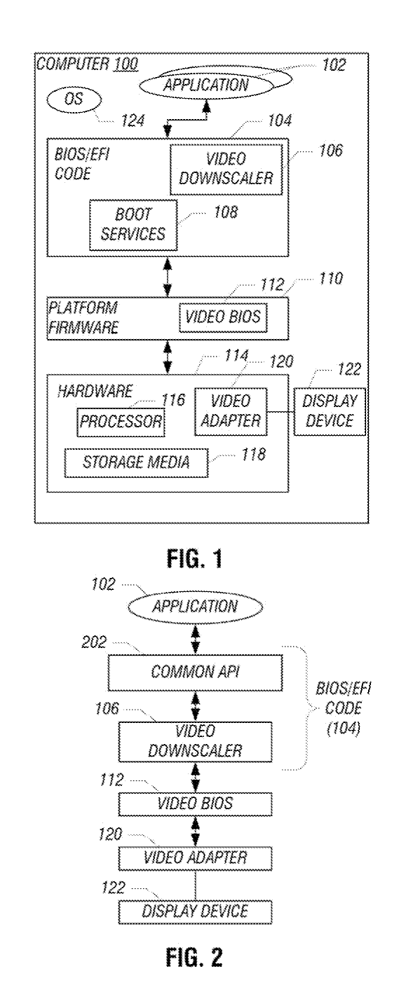

FIG. 1 is a block diagram of an exemplary computer 100, which includes software applications 102 and BIOS/EFI code 104. The BIOS/EFI code 104 includes code 108 to perform boot services and a video downscaler 106. Note that the BIOS/EFI code 104 can also include other code that is not depicted in FIG. 1 for performing other tasks.

The computer 100 also includes an operating system 124 that is loaded by the BIOS/EFI code at the end of a boot procedure.

Platform firmware 110 is also provided between the BIOS/EFI code 104 and hardware 114 of the computer 100. The platform firmware 110 can include various code, including video BIOS code 112 (or other type of video firmware) that supports the video capabilities of the computer 100 in the pre-OS environment. Note that once the OS 124 is loaded, a video driver of the OS 124 supports the video capabilities of the computer 100, rather than the video BIOS code 112.

The hardware 114 of the computer 100 includes a processor 116, storage media 118 (e.g., one or more disk-based storage devices and/or one or more integrated circuit or semiconductor memory devices), and a video adapter 120. The video adapter 120 is connected to a display device 122. The video adapter 120 works in conjunction with the video BIOS code 112 (or with a video driver of the OS 124 when the OS is loaded) to enable provision of video data to the display device 122.

As further shown in FIG. 2, various components that are employed in the pre-OS environment are shown. The application 102 outputs video data to a common application program interface (API) 202, which can be part of the BIOS/EFI code 104. The common API 202 provides API routines that can be called by applications for drawing video data on a display device. Provision of the common API 202 allows for applications designed for execution in the pre-OS environment to work with various different types of display devices, such as a display device on a notebook computer, an externally connected display device (such as a display device connected through a Universal Serial Bus or USB port), or a display device connected over a network.

Application video data received by the common API 202 is forwarded to the video downscaler 106, which determines whether or not modification of the video resolution of the application video data is to be performed. If video resolution modification does not have to be performed, then the video downscaler 106 just forwards the application video data to the video BIOS code 112 without modification. However, if video resolution modification has to be performed, then the video downscaler 106 applies video resolution modification to the application video data, and the modified application video data is then provided by the downscaler 106 to the video BIOS code 112.

The video BIOS code 112 in turn provides application video data received from the video downscaler 106 to the video adapter 120, which in turn outputs the video data to the display device 122 for display.

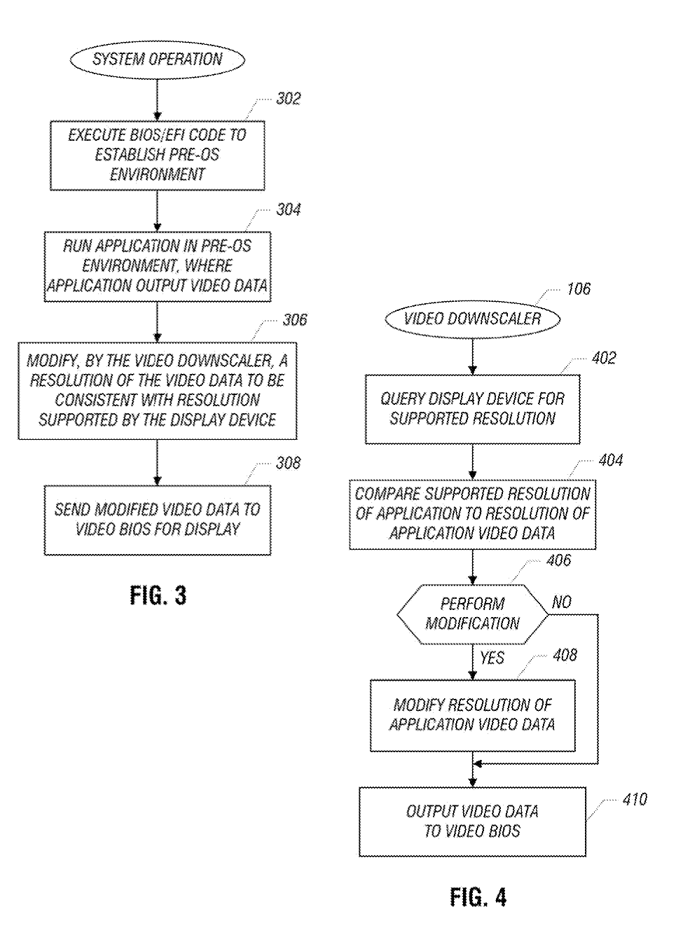

FIG. 3 is a flow diagram of system operation according to an embodiment. Upon system startup, BIOS/EFI code is executed (at 302), such as by the processor 116 of the computer 100 (FIG. 1). Execution of the BIOS/EFI code establishes a pre-OS environment. In the pre-OS environment, an application (102) is run (at 304), where the application 102 outputs video data.

If video resolution modification is to be performed, the video downscaler 106 modifies (at 306) a resolution of the video data from the application to be consistent with a resolution supported by the display device 122. The modified video data is then sent (at 308) to the video BIOS code 112 to cause the video data to be displayed.

FIG. 4 is a flow diagram of tasks performed by the video downscaler 106 according to an embodiment. The video downscaler 106, when invoked (such as by the common API 202), queries (at 402) the display device for the supported resolution. Note that querying the display device involves querying the video BIOS code 112, which contains information regarding the video resolution that is supported by the video BIOS code 112. For example, the video BIOS code 112 may support an 800×600 resolution, or alternatively, the BIOS code 112 may support a 1024×720 resolution. Either of these video resolutions may be incompatible with the resolution of the application video data, which may be at 1024×768.

The video downscaler 106 compares (at 404) the supported resolution to the resolution of the application video data. The video downscaler 106 then determines (at 406) whether video resolution modification is to be performed. If not, then the application video data can be directly output to the video BIOS code 112 without modification. However, if video resolution modification is to be performed, the video downscaler 106 modifies (at 408) the resolution of the application video data. The modified application video data is then output to the video BIOS code 112.

In some implementations, such as in embodiments where the supported resolution of the display device is 800×600, the modification by the downscaler 106 may be to transform each block of 4×4 pixels of the video data into a block of 3×3 pixels, where the values assigned to the pixels in the 3×3 block are based on averaging values of the pixels in the 4×4 block. Note that the original video data (which may have a resolution of 1024×768 pixels) can be divided into blocks, such as the 4×4 blocks noted above. After transforming the 4×4 blocks to 3×3 blocks, the resolution of the video data is decreased by about 25% along each of horizontal and vertical directions of the video data. On the other hand, if the supported resolution of the display device is 1024×720, then the video resolution modification may be performed only in the vertical direction, in order to obtain a final resolution less than or equal to the desired resolution in both the vertical and horizontal directions.

In other implementations, other resolutions of the application video data may be employed. Also, different display devices support different resolutions.

After downscaling, there may be portions on the sides or the top and bottom margins of the video data that are empty. The video downscaler 106 can provide a border around the video data to fill in the empty portions prior to display.

Note that the modification of the resolution of the application video data is performed transparently to the application. The application may be provided with feedback (such as from the common API 202 in FIG. 2) indicating that the original resolution (e.g., 1024×768) is supported by the EFI environment, but only because of use of the video downscaler. By employing the video downscaler 106 (or other video resolution modifier module) according to some embodiments, the application that outputs video data in a pre-OS environment does not have to be changed, which helps to reduce development costs and avoids delays in product release.

Instructions of software described above (including the BIOS/EFI code 104, boot services code 108, video downscaler 106, video BIOS code 112, applications 102, and OS 124 of FIG. 1) are loaded for execution on a processor (such as processor 116 in FIG. 1). The processor includes microprocessors, microcontrollers, processor modules or subsystems (including one or more microprocessors or microcontrollers), or other control or computing devices. As used here, a “processor” refers to a single component or to plural components (e.g., one or plural CPUs).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method comprising:
executing code (104) providing boot services to establish a pre-operating system (OS) environment in a computer (100);
running an application (102) in the pre-OS environment, wherein the application outputs video data for display at a display device (122) of the computer; and
modifying, by a video resolution modifier module (106) executing in the computer in the pre-OS environment, a video resolution of the video data from the application to be consistent with a video resolution supported by the display device.

2. The method of claim 1, wherein modifying the video resolution by the video resolution modifier module comprises modifying the video resolution by the video resolution modifier module that is part of the code.

3. The method of claim 1, wherein executing the code comprises executing BIOS (Basic Input Output System) code.

4. The method of claim 1, wherein executing the code comprises executing EFI (Extensible Firmware Interface) code.

5. The method of claim 1, further comprising sending the video data having the modified resolution to video firmware to allow for display of the video data at the display device.

6. The method of claim 5, further comprising determining the video resolution supported b the display device by determining the video resolution supported by the video firmware.

7. The method of claim 6, wherein the video resolution supported by the video firmware is lower than the video resolution of the video data from the application.

8. The method of claim 1, further comprising the code loading the operating system after the running and modifying tasks.

9. The method of claim 1, further comprising:
determining whether the video resolution of the video data from the application is supported by the display device,
wherein performing the modifying is in response to determining that the video resolution of the video data from the application is not supported by the display device.

10. The method of claim 9, further comprising:
sending the video data from the application to video firmware without changing the video resolution of the video data in response to determining that the video resolution of the video data is supported by the display device.

11. A computer (100) comprising:
a processor (116);
code (104) executable on the processor to establish a pre-operating system environment in the computer; and
a video resolution modifier module (106) executable on the processor, in the pre-OS environment, to:
determine if a video resolution of application video data is supported by a display device (122);
in response to determining that the resolution of the application video data is supported by the display device, cause display of the application video data at the display device without modifying the video resolution of the application video data; and
in response to determining that the video resolution of the application video data is not supported by the display device, modifying the video resolution of the application video data and causing the modified application video data to be displayed at the display device.

12. The computer of claim 11, further comprising providing, from an application programming interface, information regarding a resolution that is supported due to performance of the video resolution modifying.

13. The computer of claim 11, wherein determining if the video resolution of the application video data is supported by the display device is based on accessing video firmware that enables display of video data at the display device.

14. The computer of claim 11, wherein the video resolution of the application video data is modified by downscaling the video resolution of the application video data.

15. An article comprising at least one computer-readable storage medium containing instructions that upon execution by a computer (100) cause the computer to:
run code (104) to establish a pre-operating system (OS) environment;
generate, in the pre-OS environment, video data for display at a display device (122), wherein the video data has a first video resolution; and
modify a video resolution of the video data to provide a second video resolution, wherein the video data having the second video resolution is output for display at a display device.

16. The article of claim 15, wherein the instructions upon execution cause the computer to further:
determine whether the first video resolution is supported by the display device, wherein the modifying is performed in response to determining that the first video resolution is not supported by the display device; and
output the video data with the first video resolution for display at the display device in response to determining that the first video resolution is supported by the display device.
